(19) United States
(12) Patent Application Publication
(10) Pub. No.: US 2026/0363210 A1
(43) Pub. Date: Nov. 19, 2026

(54) ILLUMINATED ANIMAL COLLAR DEVICE

(71) Applicant: Bobbette Mower, Rigby, ID (US)

(72) Inventor: Bobbette Mower, Rigby, ID (US)

(21) Appl. No.: 19/668,873

(22) Filed: May 6, 2026

Related U.S. Application Data
(60) Provisional application No. 63/804,756, filed on May 13, 2025.

(51) Int. Cl. A01K 27/00; F21S 9/03; F21V 23/04

(52) U.S. Cl. CPC A01K 27/006; A01K 27/001; F21S 9/037; F21V 23/0435

(57) ABSTRACT

The device is an animal collar with an adjustable fastening assembly. An illumination assembly with multiple LEDs is distributed along the collar body, providing selectable colors, brightness levels, and lighting modes such as steady, flashing, and pulsing. A battery powers the illumination assembly and may be supplemented by a solar energy collection assembly that converts ambient light into stored electrical energy. A control circuit manages power distribution and operation of the illumination assembly and may connect to a receiver module for remote control via a transmitter with user inputs. The device may also include a charging interface.

### CROSS-REFERENCE TO RELATED APPLICATION

The present application claims priority to, and the benefit of, U.S. Provisional Application No. 63/804,756, which was filed on May 13, 2025, and is incorporated herein by reference in its entirety.

### FIELD OF THE INVENTION

The present invention relates generally to the field of animal collars. More specifically, the present invention relates to an animal collar that emits visible light in selectable colors, brightness levels, and patterns to enhance visibility in low-light conditions, and wherein the collar comprises a solar panel for energy capturing and generation. Accordingly, the present disclosure makes specific reference thereto. Nonetheless, it is to be appreciated that aspects of the present invention are also equally applicable to other like applications, devices, and methods of manufacture.

### BACKGROUND

Pets are frequently exposed to hazardous conditions during nighttime hours due to reduced visibility in outdoor environments. Motorists, pedestrians, and cyclists may be unable to detect the presence of a pet crossing or standing near roadways, which increases the likelihood of collisions. In residential and rural settings, pet owners often experience difficulty locating animals that roam beyond immediate sight in low-light conditions. This lack of visibility can result in prolonged searches and increased stress for both the pet and the owner. Additionally, pets that wander into neighboring properties at night may not be easily identifiable, leading to confusion or concern among nearby residents. Conventional collars do not provide sufficient illumination to address these challenges. Detachable lighting accessories are often unreliable, uncomfortable, or easily lost during activity. There exists a clear need for an integrated solution that enhances visibility while maintaining comfort and functionality. Without such a solution, risks associated with nighttime pet activity remain significant and unresolved.

Therefore, there exists a long-felt need in the art for a device that improves visibility of a pet in low-light and nighttime environments. There also exists a long-felt need in the art for an illuminated animal collar device that enhances safety during outdoor activity without requiring detachable lighting components. Moreover, there exists a long-felt need in the art for an illuminated animal collar device that enables identification of a pet by owners and nearby individuals in dark conditions.

The subject matter disclosed and claimed herein, in one embodiment thereof, comprises an illuminated animal collar device. The device is comprised of a collar body that comprises an adjustable fastening assembly configured to secure the collar body in a comfortable and stable position. The device further comprises an illumination assembly comprising a plurality of light emitting diodes distributed along the collar body and configured to emit light in selectable colors, brightness levels, and illumination patterns including steady, flashing, and pulsing sequences. The device has a battery electrically coupled to the illumination assembly and configured to store electrical energy, wherein the power system may further comprise a solar energy collection assembly configured to capture ambient light and convert the captured light into stored electrical energy. The device also has a control circuit configured to regulate power distribution and control activation of the illumination assembly, wherein the control circuit may be operatively connected to a receiver module configured to receive signals from a remote control having a transmitter and user input elements for selective operation of the illumination assembly. The device may further comprise a charging interface.

In this manner, the illuminated animal collar device of the present invention accomplishes all the foregoing objectives and provides a continuous and enhanced visibility of a pet in low-light environments through the illumination assembly and configurable light patterns. The design further eliminates the need for detachable lighting components, thereby improving comfort and reliability during use. The inclusion of a rechargeable power system and solar energy collection assembly supports sustained operation without frequent manual intervention. As a result, the device reduces risks associated with nighttime pet activity, improves identification by owners and others, and addresses the longstanding challenges related to pet visibility and safety.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an illuminated animal collar device. The device is a collar configured for use on a pet to enhance visibility in low-light or nighttime environments. The device provides active visual signaling through light emission to increase awareness of the pet's presence to nearby individuals. Emitted light patterns improve tracking of the pet's location while serving as a warning indicator to reduce accidental injury.

The device is comprised of a collar body formed from durable, flexible, and water-resistant materials for extended outdoor wear. The collar body is further comprised of a fastening assembly configured to secure the collar around the pet and allow adjustment for different sizes while maintaining a secure and comfortable fit. The collar body is further comprised of an attachment point configured to receive an identification tag or accessory, wherein the attachment point may be fixed or rotatable.

The collar body is further comprised of a solar energy collection assembly including one or more solar panels positioned along an exterior surface. The solar energy collection assembly is configured to capture ambient light and convert the captured light into electrical energy to charge a battery during normal wear.

The device is further comprised of a battery electrically coupled to the solar energy collection assembly and a charging interface, wherein the battery stores electrical energy for later use. The battery may be rechargeable or replaceable and may be removably positioned within a sealed compartment of the collar body.

The collar body is further comprised of an illumination assembly including a plurality of light-emitting diodes distributed along the collar body and configured to resist water ingress. The illumination assembly emits light at various brightness levels, colors, and patterns including steady, flashing, pulsing, alternating, or programmable sequences, and is electrically coupled to the battery.

The device is further comprised of a control circuit configured to regulate power distribution and control activation of the illumination assembly. The device is further comprised of a receiver module electrically coupled to the control circuit. The device is also comprised of a remote control including a transmitter, a battery, and a charging interface. The remote control is configured to selectively control operation of the illumination assembly via one or more input elements.

The collar body is further comprised of a charging interface configured to receive electrical energy, wherein the charging interface may include various connector types. The device is further comprised of a charging cord having a first end configured to connect to the charging interface and a second end configured for connection to an electrical outlet. The charging cord is further configured to interface with the charging interface of the remote control. In another embodiment, the charging cord is configured to interface with a charging base configured to supply electrical energy to the batteries. The charging base may include one or more charging interfaces configured to engage corresponding interfaces of the collar body and the remote control.

Accordingly, the illuminated animal collar device of the present invention is particularly advantageous as it provides continuous and enhanced visibility of a pet in low-light environments through the illumination assembly and configurable light patterns. The design further eliminates the need for detachable lighting components, thereby improving comfort and reliability during use. The inclusion of a rechargeable power system and solar energy collection assembly supports sustained operation without frequent manual intervention. As a result, the device reduces risks associated with nighttime pet activity, improves identification by owners and others, and addresses the longstanding challenges related to pet visibility and safety. In this manner, the illuminated animal collar device overcomes the limitations of existing pet collars and light sources known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a collar body of one potential embodiment of an illuminated animal collar device of the present invention in accordance with the disclosed architecture;

FIG. 2 illustrates a perspective view of a remote of one potential embodiment of an illuminated animal collar device of the present invention in accordance with the disclosed architecture; and

FIG. 3 illustrates a perspective view of a charging base of one potential embodiment of an illuminated animal collar device of the present invention wherein the collar body is charging within the charging base in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that improves visibility of a pet in low-light and nighttime environments. There also exists a long-felt need in the art for an illuminated animal collar device that enhances safety during outdoor activity without requiring detachable lighting components. Moreover, there exists a long-felt need in the art for an illuminated animal collar device that enables identification of a pet by owners and nearby individuals in dark conditions.

The present invention, in one exemplary embodiment, is comprised of an illuminated animal collar device. The device is a collar for a pet configured to improve visibility in low-light or nighttime environments. Light emission provides active signaling to increase awareness of the pet's presence, while emitted patterns assist with location tracking and reduce the risk of accidental injury.

The device is comprised of a collar body formed from durable, flexible, and water-resistant materials for outdoor use. The collar body is further comprised of a fastening assembly configured for secure and adjustable attachment around the pet, and an attachment point configured to receive an identification tag or accessory, wherein the attachment point may be fixed or rotatable.

The collar body is further comprised of a solar energy collection assembly including one or more solar panels positioned along an exterior surface. The solar energy collection assembly captures ambient light and converts the captured light into electrical energy to charge a battery.

The device is further comprised of a battery electrically coupled to the solar energy collection assembly and a charging interface, wherein the battery stores electrical energy. The battery may be rechargeable or replaceable and may be removably positioned within a sealed compartment of the collar body.

The collar body is further comprised of an illumination assembly including a plurality of light-emitting diodes distributed along the collar body and configured to resist water ingress. The illumination assembly emits selectable brightness levels, colors, and patterns including steady, flashing, pulsing, alternating, or programmable sequences, and is electrically coupled to the battery.

The device is further comprised of a control circuit configured to regulate power and control activation of the illumination assembly, and a receiver module electrically coupled to the control circuit. The device is further comprised of a remote control including a transmitter, a battery, and a charging interface, wherein the remote control is configured to control operation of the illumination assembly via one or more input elements.

The collar body is further comprised of a charging interface configured to receive electrical energy. The device is further comprised of a charging cord configured to connect to the charging interface and to an electrical outlet, wherein the charging cord is further configured to interface with the remote control. In another embodiment, the charging cord interfaces with a charging base configured to supply electrical energy to the batteries, wherein the charging base includes one or more charging interfaces configured to engage corresponding interfaces of the collar body and the remote control.

As such, the device provides enhanced pet visibility through integrated illumination without detachable components, improving comfort and reliability. The device further supports sustained operation through a rechargeable power system and optional solar energy collection assembly, thereby reducing risks associated with low-light conditions and improving pet identification and safety.

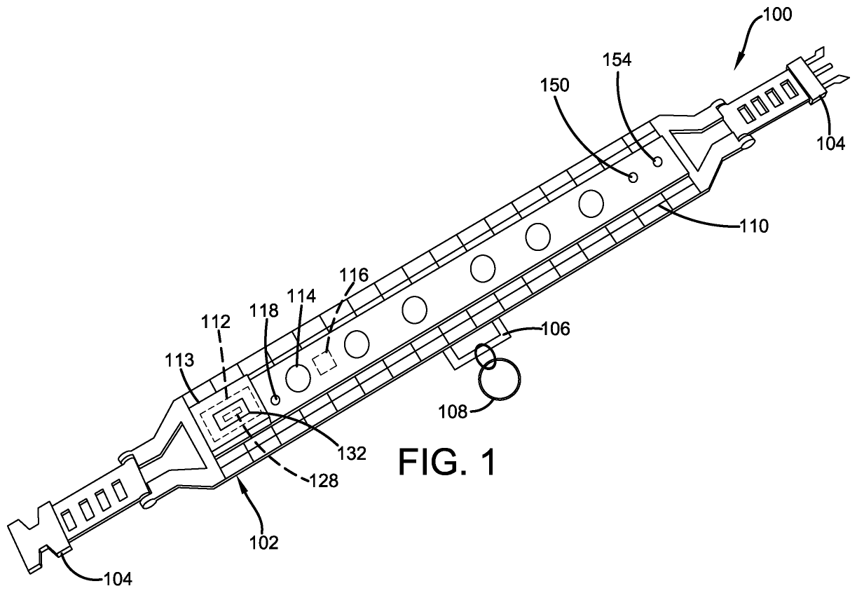

Referring initially to the drawings, FIG. 1 illustrates a perspective view of a collar body 102 of one potential embodiment of an illuminated animal collar device 100 of the present invention in accordance with the disclosed architecture. The device 100 is an illumination collar configured for use on a pet, such as but not limited to a dog, wherein the primary function of the device 100 is to enhance visibility of the pet in low-light or nighttime environments. More specifically, the device 100 is configured to provide active visual signaling through light emission, thereby increasing awareness of the pet's presence to nearby individuals, such as but not limited to vehicle operators, pedestrians, and pet owners. The emitted light patterns of the device 100 may also improve tracking of the pet's location in dark environments while simultaneously serving as a warning indicator to reduce the likelihood of accidental injury.

The device 100 is comprised of a collar body 102 formed from durable materials including rubber, synthetic polymers, thermoplastic elastomers, silicone-based materials, or other flexible and water-resistant materials configured for extended wear in outdoor environments. The collar body 102 may further be comprised of a fastening assembly 104 such as but not limited to a buckle, side-release clasp, snap-fit connector, hook-and-loop interface, or adjustable strap mechanism configured to secure the collar body 102 around the neck of the pet. The fastening assembly 104 may be adjustable to accommodate different neck sizes, breeds, or growth stages while maintaining a secure and comfortable fit during use. The collar body 102 may further be comprised of an attachment point 106 such as but not limited to a metallic or polymer ring, loop, or reinforced bracket configured to receive an identification tag 108 or similar accessory, wherein the attachment point 106 may be fixed or rotatably coupled.

The collar body 102 may further be comprised of a solar energy collection assembly 110, as seen in FIG. 1, such as but not limited to one or more solar panels embedded within or mounted along an exterior surface of the collar body 102, wherein the solar panels may be flexible, segmented, or rigid and arranged in a linear or distributed configuration to maximize light exposure. The solar energy collection assembly 110 may be configured to passively and continuously capture ambient daylight and convert the captured light into electrical energy, thereby allowing a battery 112 of the device 100 to charge during normal daytime wear.

The device 100 may further be comprised of a battery 112 electrically coupled to the solar energy collection assembly 110 and a charging interface 128, wherein the battery 112 may be configured to store electrical energy for later use. In one embodiment, the battery 112 may be rechargeable such as but not limited to lithium-ion, lithium-polymer, or nickel-metal hydride. In another embodiment, the battery 112 may be non-rechargeable and replaceable. In a further embodiment, the battery 112 may be removably positioned within a sealed compartment 113 of the collar body 102.

The collar body 102 may further be comprised of an illumination assembly 114 (as seen in FIG. 1) such as but not limited to a plurality of light-emitting diodes distributed along the collar body 102, wherein the plurality of light-emitting diodes may be waterproof to prevent water ingress during exposure to rain, splashing, or submersion. The illumination assembly 114 may be configured to emit multi-directional light at various brightness levels, illumination colors, and illumination patterns, including such as but not limited to steady illumination, intermittent flashing, pulsing sequences, alternating light sequences, or programmable sequences. The illumination assembly 114 may be electrically coupled to the battery 112. The assembly 114 may be positioned circumferentially around the body 102.

The device 100 may further be comprised of a control circuit 116 configured to regulate power distribution and control activation of the illumination assembly 114. The device 100 may also be comprised of a receiver module 118 electrically coupled to the control circuit 116. In one embodiment, the device 100 comprises a sensor 150, such as but not limited to a dusk/dawn sensor 152, electrically coupled to the control circuit 116. The dusk/dawn sensor 150 may be configured to detect ambient light levels surrounding the device 100 and generate a sensor signal corresponding to a detected light intensity. The control circuit 116 may be configured to receive the sensor signal from the dusk/dawn sensor 150 and selectively activate the illumination assembly 114 when the detected light intensity falls below a predetermined threshold. The control circuit 116 may further be configured to deactivate the illumination assembly 114 when the detected light intensity rises above the predetermined threshold.

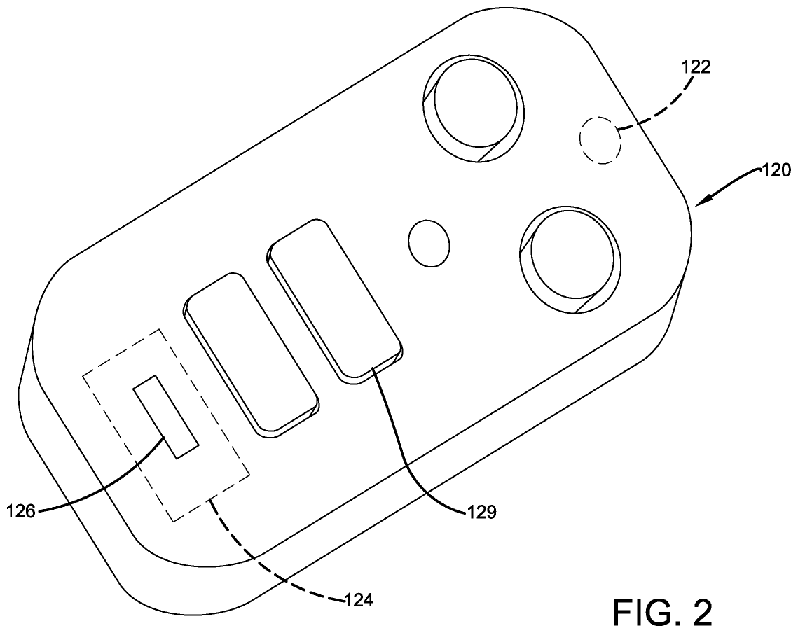

The device 100 may further be comprised of a remote control 120, as seen in FIG. 2, wherein the remote control 120 may be comprised of a transmitter 122, a battery 124, and a charging interface 126. The charging interface 126 may include such as but not limited to a USB-based port including USB-A, USB-C, or micro-USB configurations, a barrel connector, magnetic charging contacts, or other conductive interfaces. The remote control 120 may be configured to selectively control brightness levels, illumination colors, and illumination patterns of the illumination assembly 114 via one or more input elements 129 such as but not limited to buttons. The device 100 may further be comprised of a transmitter 154 electrically coupled to the control circuit 116 and configured to enable wireless communication between the control circuit 116 and an external smart device such as but not limited to a smartphone, tablet, laptop computer, desktop computer, wearable device, etc.

The collar body 102 may further be comprised of a charging interface 128 such as but not limited to a charging port configured to receive electrical energy. The charging interface 128 may include such as but not limited to USB-C ports, micro-USB ports, magnetic charging contacts, sealed pin connectors, or inductive charging interfaces. In one embodiment, the charging interface 128 may be covered by a waterproof cover 132, wherein the waterproof cover 132 may be comprised of a flexible cap, hinged seal, or gasketed barrier configured to prevent moisture ingress when the charging interface 128 is not in use.

The device 100 may further be comprised of a charging cord 134 having a first end 136 configured to releasably connect to the charging interface 128 and a second end 138 configured as a wall plug for insertion into a standard electrical outlet. The first end 136 may be further configured to interface with the charging interface 126 of the remote control 120.

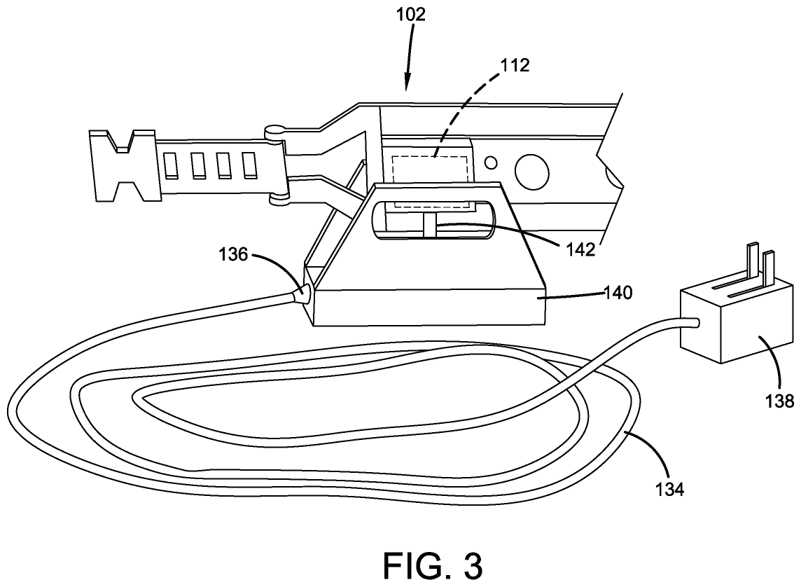

In a different embodiment, the first end 136 may be configured to removably and fixedly interface with a charging base 140 (as seen in FIG. 3), wherein the charging base 140 may be configured to receive the charging cord 134 and supply electrical energy to the batteries 112,124. The charging base 140 may further be comprised of one or more charging interfaces 142 such as but not limited to recessed or extended connectors, contact pads, etc. configured to receive and engage the charging interfaces 126,128 of the collar body 102 and/or remote 120.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “illuminated animal collar device” and “device” are interchangeable and refer to the illuminated animal collar device 100 of the present invention.

Notwithstanding the foregoing, the illuminated animal collar device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the illuminated animal collar device 100 as shown in the FIGS. are for illustrative purposes only, and that many other sizes and shapes of the illuminated animal collar device 100 are well within the scope of the present disclosure. Although the dimensions of the illuminated animal collar device 100 are important design parameters for user convenience, the illuminated animal collar device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An illuminated animal collar device comprising:
a collar body;
a fastening assembly positioned on the collar body;
an illumination assembly positioned on the collar body;
a solar energy collection assembly positioned on the collar body; and
a battery electrically coupled to the solar energy collection assembly and configured to store an electrical energy.

2. The illuminated animal collar device of claim 1, wherein the collar body further comprises an attachment point.

3. The illuminated animal collar device of claim 1, wherein the illumination assembly is waterproof.

4. The illuminated animal collar device of claim 1 further comprising a remote.

5. The illuminated animal collar device of claim 4, wherein the remote further comprises a button.

6. The illuminated animal collar device of claim 5, wherein the button configures a brightness level of the illumination assembly.

7. The illuminated animal collar device of claim 5, wherein the button configures an illumination color of the illumination assembly.

8. The illuminated animal collar device of claim 5, wherein the button configures an illumination pattern of the illumination assembly.

9. The illuminated animal collar device of claim 1 further comprising a charging cord.

10. The illuminated animal collar device of claim 1, wherein the collar body further comprises a water-resistant material.

11. An illuminated animal collar device comprising:
a collar body;
a fastening assembly positioned on the collar body;
an illumination assembly positioned on the collar body;
a solar energy collection assembly positioned on the collar body;
a battery electrically coupled to the solar energy collection assembly and configured to store an electrical energy; and
a charging port.

12. The illuminated animal collar device of claim 11, wherein the charging port further comprises a cover.

13. The illuminated animal collar device of claim 11, wherein the battery further comprises a rechargeable battery.

14. The illuminated animal collar device of claim 11 further comprising a control circuit.

15. The illuminated animal collar device of claim 11, wherein the collar body further comprises an attachment point.

16. The illuminated animal collar device of claim 11 further comprising a charging cord.

17. An illuminated animal collar device comprising:
a collar body;
a fastening assembly positioned on the collar body;
an illumination assembly positioned on the collar body;
a solar energy collection assembly positioned on the collar body;
a battery electrically coupled to the solar energy collection assembly and configured to store an electrical energy;
a charging port; and
a charging base.

18. The illuminated animal collar device of claim 17 further comprising a control circuit.

19. The illuminated animal collar device of claim 17, wherein the collar body further comprises an attachment point.

20. The illuminated animal collar device of claim 17, wherein the charging base further comprises a charging interface.
